(19) United States
(12) Patent Application Publication
(10) Pub. No.: US 2010/0162387 A1
(43) Pub. Date: Jun. 24, 2010

(54) Mobile device with separate access to private and public information stored in the device

(76) Inventors: Ernest Samuel Baugher, Buda, TX (US); Venkata Chalapathi Majeti, Naperville, IL (US)

Correspondence Address: Carmen Patti Law Group , LLC, ONE N. LASALLE STREET, 44TH FLOOR, CHICAGO, IL, 60602, US

(21) Appl. No.: 12/584,422

(22) Filed: Sep. 4, 2009

Related U.S. Application Data
(63) Continuation-in-part of application No. 12/317,187, filed on Dec. 19, 2008.

(51) Int. Cl. H04L 9/32; G06F 21/00; G06F 17/30

(52) U.S. Cl. 726/19; 726/28

(57) ABSTRACT

An exemplary method is implemented by a wireless mobile device that transmits and receives text-based messages. Public records are stored in a public contact database in the mobile device, the public records containing public contact information for persons. Public contact information contained in a public record corresponding to a person selected by a public user is displayed upon the request of any public user of the device. Private records are stored in a private contact database in the mobile device, the private records containing private contact information for persons. Upon a valid password being received by the device from a private user, access to the private contact information is provided to the private user. In response to the receipt of a request from the private user, private contact information for a selected person from a corresponding private record is displayed on the screen of the mobile device.

### CROSS REFERENCE TO RELATED APPLICATION

This is a continuation-in-part application that claims the benefit of the prior filed U.S. patent application Ser. No. 12/317,187 filed Dec. 19, 2008 entitled “WIRELESS MOBILE DEVICE WITH PRIVACY GROUPS THAT INDEPENDENTLY CONTROL ACCESS TO RESIDENT APPLICATION PROGRAMS” that claimed the benefit of the prior filed U.S. patent application Ser. No. 12/220,135 filed Jul. 22, 2008, all of which are incorporated herein. This application is related to the concurrently filed application, “WIRELESS MOBILE DEVICE WITH AUTOMATIC SEGREGATION OF RECEIVED MESSAGES FOR PRIVATE AND PUBLIC ACCESS”.

### BACKGROUND

This invention relates to wireless mobile communication devices capable of receiving and transmitting text-based messages. It is especially, but not exclusively, directed to providing the user with privacy for certain stored information while providing public access to other stored information.

Cellular telephones that are multimedia message service (MMS) and/or SMS capable can run a variety of resident application programs beyond basic voice communications. Functions such as address books, contact lists, and text messaging applications are each typically represented by icons displayed on the screen of the cellular telephone or personal digital assistant. To access a particular function, the user can highlight or point and click on an icon displayed on the screen associated with the function/application desired to be accessed. Once a user has the ability to access and operate the device, the user has access to all the information stored on the device even if the user is not the owner (normal user) of the device. For example, a guest user can access and view the owner's list of contacts stored in the device's contact database along with all contact information stored for each person in the contact database. And the guest user can access and view all messages stored in the device's inbox and outbox (sent messages). Although the owner may desire to allow temporary usage of the device by a guest such as to make a telephone call or send a text-based message, confidential information of the owner that is stored in the device may intentionally or unintentionally viewed by the guest user.

### SUMMARY

An object of the present invention is to provide the owner of the mobile device with privacy by which a guest user can be granted permission to temporarily operate the device including access to stored information designated as public but is prevented from accessing stored information designated as private.

An exemplary method is implemented by a wireless mobile device that transmits and receives text-based messages. As used herein reference to a ‘text-based message’ means any type of information communicated via SMS format. Public records are stored in a public contact database in the mobile device, the public records containing public contact information for persons. Public contact information contained in a public record corresponding to a person selected by a public user is displayed upon the request of any public user of the device. Private records are stored in a private contact database in the mobile device, the private records containing private contact information for persons. Upon a valid password being received by the device from a private user, access to the private contact information is provided to the private user. In response to the receipt of a request from the private user, private contact information for a selected person from a corresponding private record is displayed on the screen of the mobile device.

Another exemplary embodiment of the invention includes the wireless mobile device that substantially implements the above method.

A further exemplary embodiment of the invention includes an article with computer readable instructions that substantially implement the above method.

### DESCRIPTION OF THE DRAWINGS

Features of exemplary implementations of the invention will become apparent from the description, the claims, and the accompanying drawings in which:

FIG. 1 is a block diagram of an exemplary system suited for support of a mobile device that incorporates an embodiment of the present invention.

FIG. 2 is a block diagram of an exemplary wireless mobile device in accordance with an embodiment of the present invention.

FIG. 3 is a functional view of the system of the wireless mobile device in which privacy is provided in accordance with an embodiment of the present invention.

FIG. 4 is a view of a representative screen of the wireless mobile device showing an exemplary private contact screen in accordance with the present invention.

FIG. 5 is a view of a representative screen of the wireless mobile device showing an exemplary public contact screen.

FIG. 6 is a view of exemplary confidential information stored in the private contact database in accordance with the present invention.

FIG. 7 shows exemplary steps of an embodiment of a method for creating or editing confidential information stored in the private contact database in accordance with the present invention.

FIG. 8 shows exemplary steps of an embodiment of a method for displaying a private contact screen in accordance with the present invention.

FIG. 9 shows exemplary steps of an embodiment of a method for displaying a public contact screen.

FIG. 10 is a view of a representative known contact screen of the wireless mobile device.

FIGS. 11 and 12 show an exemplary contact screen of the wireless mobile device in accordance with an embodiment of the present invention by which multiple addressees can be simultaneously selected by the user.

FIG. 13 is a flow diagram of an exemplary method by which the contact function interacts with the compose function on the wireless mobile device in accordance with the present invention.

FIG. 14 is a flow diagram of an exemplary method for selecting multiple members in the contact screen and updating the To field of the compose screen to reflect those that were selected in the contact screen in one operation in accordance with the present invention.

### DETAILED DESCRIPTION

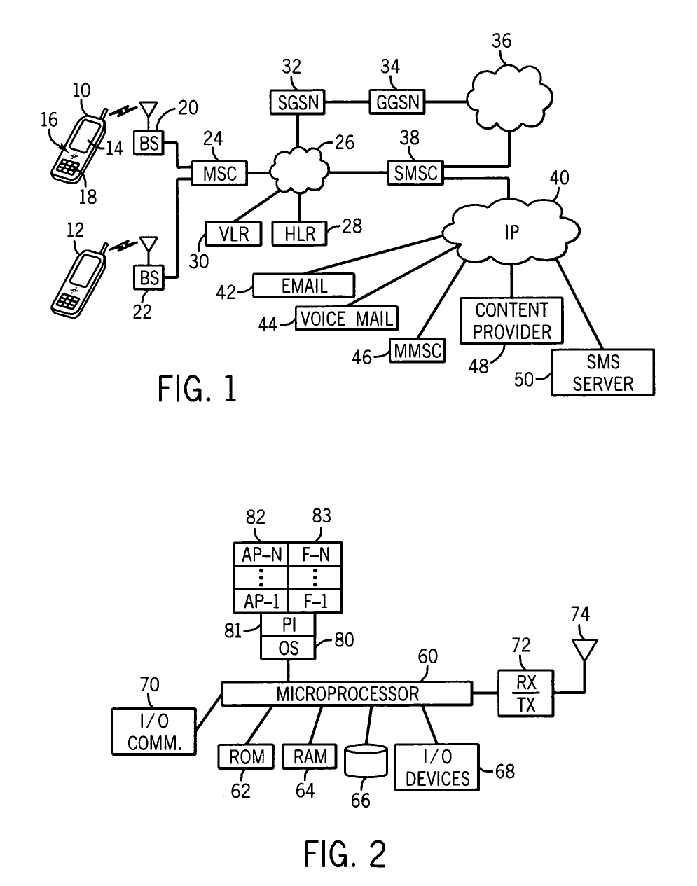

Referring to FIG. 1, an exemplary telecommunication network includes a system that supports wireless cellular subscribers with voice communications, multimedia message service (MMS), email and/or SMS messaging. First and second subscribers utilize mobile devices 10 and 12 such as a cellular telephone with these capabilities. As used herein, a mobile device means a wireless portable SMS capable two-way communications apparatus intended to be held in one hand during normal operation, e.g. a cellular telephone or personal digital assistant (PDA), and does not include a laptop computer. Each exemplary mobile device includes a display screen 14, user input controls 16 associated with cursor and screen control, and a keypad and/or keyboard 18 for accepting additional user inputs.

The system includes base stations (BS) 20 and 22 that support wireless communications between the devices 10 and 12, respectively, as controlled by a mobile switching center (MSC) 24. Signaling and data information are carried to and from the MSC by a supporting communication system 26, e.g. signaling system 7 (SS7). Also coupled to the system 26 is a home location register (HLR) 28 and a visiting location register (VLR) 30 which facilitate registration, authentication and location information related to the mobile devices.

In this illustrative example, communications are provided by a general public radio service (GPRS). Accordingly, communications with a serving GPRS service node (SGSN) 32 is also supported by system 26. Communications between the SGSN 32 and other networks 36, e.g. public switched telephone network (PSTN), general services mobile (GSM) network or code division multiple access (CDMA) network, is facilitated by a gateway GPRS service node (GGSN) 34.

A SMS controller (SMSC) 38 is coupled to system 26 and supports SMS communications among the mobile devices 10/12 and other devices which may be coupled to the internet protocol (IP) network 40. The mobile devices 10/12 may also support other communication services such as MMS, email, a browser for internet access, and/or other data applications. A variety of services, functions and apparatus may be connected to the network 40. For example, servers or other appropriate nodes may provide email service 42 and voice mail service 44 for the mobile devices. A multimedia message service center (MMSC) 46 may provide support for multimedia communications, e.g. pictures or video information. A content provider server 48 is merely illustrative of the many possible sources of information which are available over the Internet. An SMS server 50 provides an interface between communications utilizing the SMS protocol and other communication protocols such as packets transmitted over the Internet.

FIG. 2 is a block diagram of an illustrative embodiment of a mobile device, e.g. mobile device 10. The functionality of the mobile device is provided by microprocessor 60 which is supported by read-only memory (ROM) 62, random access memory (RAM) 64, and nonvolatile memory 66 such as flash memory, EEPROM, etc. Input/output (I/O) devices 68 may include input devices such as a keypad, keyboard, touchpad, and other buttons such as for cursor movement, screen selection, etc., microphone, and an input port jack for wire-based communications with other devices. The output devices include a display screen 14 and a speaker. A separate microprocessor (not shown) can be dedicated to rendering the video display if the computational load for creating images is too high for the primary microprocessor 60 to handle in addition to the other demands. An input/output communication module 70 supports two-way communications between the microprocessor 60 and external devices such as connected by a cable to the input port jack, by infrared (IR) beam, or by Bluetooth technology. A transmit and receive module 72 coupled to antenna 74 provides radio frequency (RF) communication support with base stations and/or other wireless devices such as by Wi-Fi. The microprocessor 60 operates under the control of an operating system (OS) 80 which provides basic operational functionality, e.g. exemplary operating systems are or are used in products by: Symbian, Windows Mobile, Palm, Research In Motion (RIM), iPhone, etc. The OS supports application programs 82 that provide higher-level functionality, files 83 that may contain various user information, and privacy interface (PI) application 81. The microprocessor in combination with associated memory and other peripheral devices form a microprocessing unit.

The PI application 81 functions as “middleware”, i.e. software that provides an interface between the OS and the higher level applications 82 and files 83. The PI application 81 enables the user to create a first group of certain selected applications 82 and files 83 that can be accessed only after the entry of a predetermined password (privacy protected) while permitting applications and files not within the first group to be accessed without the need for the entry of the password (public or not privacy protected). The same valid password operates to protect all of the applications/files that are privacy protected. The PI function also includes encryption functionality that is integrated with the text messaging capability of the SMS mobile device. The PI function can also be incorporated within the OS. Middleware as defined herein refers to its supported functions whether disposed intermediate to the applications and the OS, or incorporated within the OS itself.

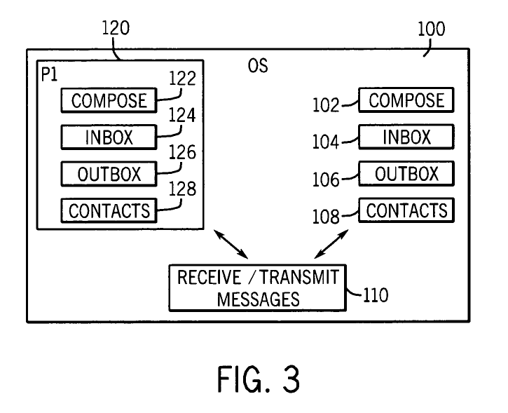

FIG. 3 shows a conceptual view of several features of an operating system (OS) 100 that supports a wireless mobile device. The operating system includes functions associated with the generation, reception, transmission and storage of messages. A compose function 102 provides the user with an interface to select the addressees one at a time to receive an originated message as well as permitting the user to input the body of the message itself. The inbox 104 provides for the storage and display of received messages which each message may be stored as an individual record. The outbox 106 provides for the storage and display of messages that have been transmitted or have been composed for transmission where each message may be stored as an individual record. The contacts function 108 stores and displays names and address information, e.g. telephone numbers, typically for people for which the user on the subject mobile device has or expects to have ongoing communications. Functions 102, 104, 106 and 108 are linked to files/records stored in the device that are public, i.e. anyone such as a guest user operating the device has access to this stored information. A receive/transmit message function 110 provides an interface between the functions 102, 104, 106 and 108, and the receiver/transmitter of the mobile device. The function 110 facilitates the formatting of information to be transmitted from the mobile device into a form suitable to be conveyed from the compose or outbox to the transmitter and formats the information obtained from the receiver into a format suitable to be transferred to the inbox.

The privacy interface application 120 includes compose 122, inbox 124, outbox 126 and contacts 128 functions that support similar functionality as described above for the corresponding functions 102, 104, 106 and 108 except that privacy is provided, i.e. access to these functions and stored information associated with these functions is only available to a user, e.g. the owner, who enters a required password. This “privacy password” is required for access to the PI application and its functions, but is not needed in order for a user to access public information on the device and perform public functions. Further the privacy password is not to be confused with a “keylock” password or similar password which is typically utilized to lock all functions of the device. The functions 122-128 also provide additional capabilities, as will be described below, beyond that provided by the corresponding functions 102, 104, 106 and 108. The receive/transmit message function 110 also provides an interface between the functions 122, 124, 126 and 128, and the receiver/transmitter of the mobile device.

An application programming interface (API) is available for the operating system of many wireless mobile devices (enhanced cellular telephones) which facilitates access by external applications to information stored under the control of the operating system and calling conventions permitting supported commands to be communicated between the application program and the operating system. The PI application utilizes the API interface to provide enhanced functionality as explained below for the user of the wireless mobile device. For example, for a Blackberry manufactured by Research in Motion provides an API.

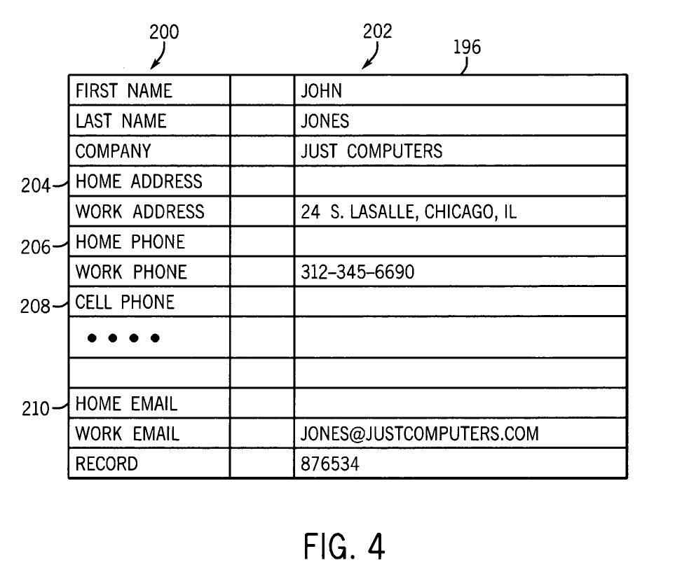

FIG. 4 shows a representative screen of the wireless mobile device showing an exemplary public contact screen 196. As used herein reference to one of the types of public screens refers to a screen and the display of corresponding stored data accessed from a corresponding public function which does not require the entry of the privacy password via the PI application to gain access to the function. The exemplary screen 196 includes a column 200 that contains a label or description of information stored in column 202. In this example, stored data is displayed in column 202 for the first name, last name, company, work address, work phone, work e-mail and record. This stored data has been input by the user in the public database/file as being public meaning that any person using the device can cause the public contact screen 196 to be displayed and upon selecting the record for John Jones will see the stored public data as shown in FIG. 4. The number displayed in the record field is typically assigned by the function upon creation of the record and is unique to stored information/records associated with “John Jones”.

It will be noted that the home address 204, home phone 206, cell phone 208 and home e-mail 210 fields display no corresponding data. The lack of displayed data for a particular field in public screen 196 does not necessarily mean that no corresponding data is available. It may be that no corresponding data has been stored for that field. However the display of no corresponding data in the public screen may be because this data has been stored by the user but designated as confidential as will be explained below.

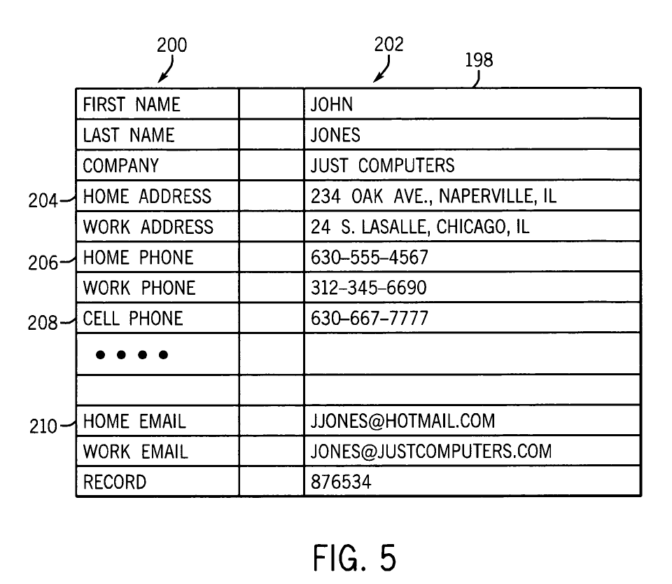

FIG. 5 is a view of a representative screen of the wireless mobile device showing an exemplary private contact screen 198. As used herein reference to a private screen refers to a screen and the display of corresponding stored data accessed from a corresponding private function which requires the entry of the privacy password via the PI application to gain access to the function. Private contact screen 198 contains in this example the same description fields in column 200 as in column 200 of the public screen 196. In addition to displaying the same public data as shown in FIG. 4, stored confidential data is also displayed in the private contact screen for home address 204, home phone 206, cell phone 208 and home e-mail 210. In order to access the private contact function 128 contained in the PI application 120, the user will have been required to enter and have validated the password required to access and open the functions contained in the PI application. Alternatively, the private contact screen may contain additional description fields and corresponding stored confidential data, neither of which is displayed for a corresponding public record when accessed from the public screen function. The same number shown in the record field for both the public and private screens identifies corresponding records for the same entry as will be explained below.

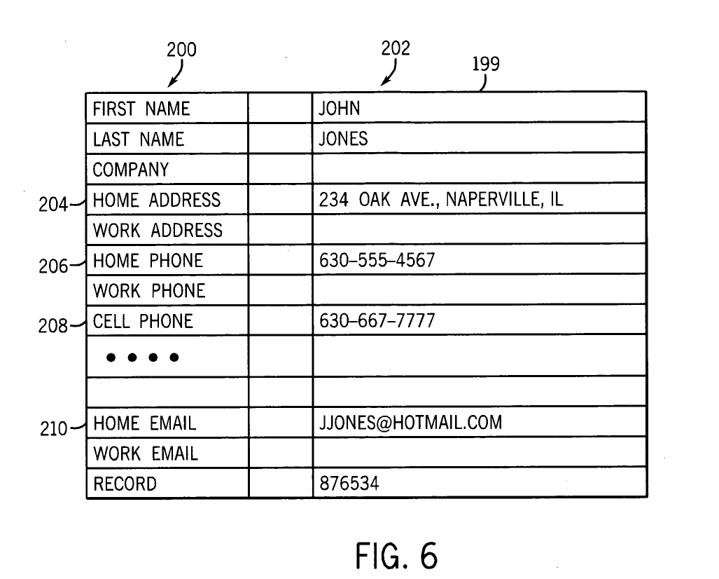

FIG. 6 is a view of information stored in a private record 199 in the private contact database in accordance with the present invention. In this illustrative example the record 199 may store only some of the publicly accessible information including the first name, last name and record number. Alternatively, the record 199 may contain no information that would be shown on access to a corresponding public record from the public contact screen. The purpose of record 199 is to store all of the confidential information for a corresponding contact entry, i.e. “John Jones”. However, in order to aid the user with the identification of the private record corresponding to a public record entry, some public information such as the first and last names may be duplicated within this private record. The public and private records may be stored in respective separate files in the database 66 where access to the file containing the private records is only permitted through functions contained in the PI application. Corresponding public and private records for the same entry can be identified by the same record number for each.

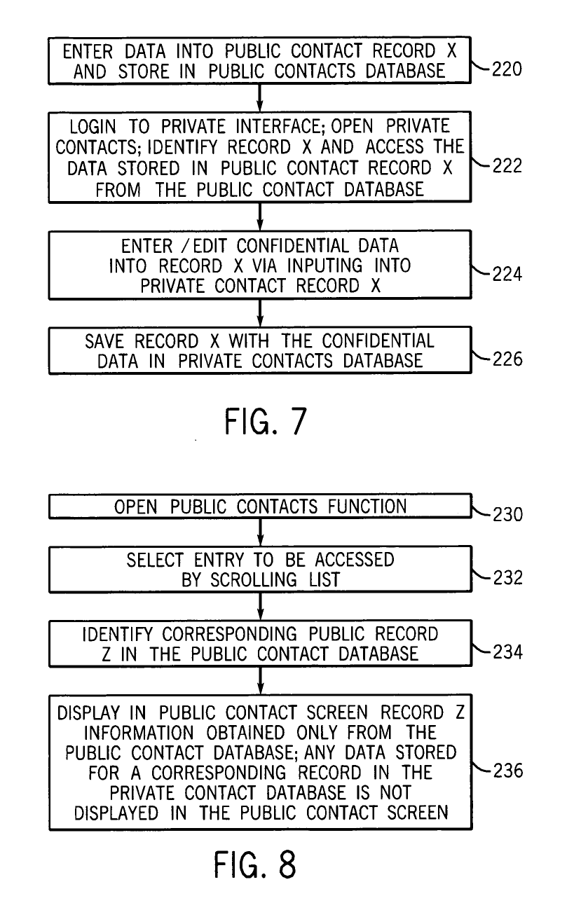

FIG. 7 shows exemplary steps of an embodiment of a method for creating and/or editing information stored in public and private records. In step 220 the user accesses the public contact records and enters data into public contact record X and stores the record in the public contacts database. It will be understood that the public and/or private databases referenced herein may be implemented in various ways including the use of a single physical database in which separate areas or files are used to store the respective public and private records/information. Because data is being entered into a public contact record, any user operating the device has access to this information. In step 222 the owner logs in to the PI application by the entry of a valid password and opens the private contacts function. The owner may then identify a desired entry to edit by scrolling through the existing records or may elect to create a new entry with a corresponding record. In this example, the owner identifies an existing entry corresponding to record X and is provided with private access to this record. Private access includes displaying the record with the data stored in the public contact record X from the public contact database as well as any existing confidential data stored in the private contact record X from the private contact database. Preferably the confidential data is displayed with different indicia on the screen to differentiate it from the public data. For example, confidential data may be displayed in a different color, font or format then that used to display the public data. In step 224 the user edits and/or enters confidential data into record X by inputting the desired information into the private contact record X. In step 226 a user saves the private record X with the confidential data in the private contacts database.

FIG. 8 shows exemplary steps of an embodiment of a method for displaying a public contact screen. In step 230 the user opens the public contact function. In step 232 the user scrolls through a listing of the available public contact entries where the list may identify each entry by name. In step 234 the user selects an existing entry corresponding to public record Z in the public contact database. In step 236 information contained in public record Z is displayed in the public contact screen. It will be noted that only information contained in the public contact database will be displayed, i.e. any confidential data stored in a corresponding private record Z in the private contact database is not accessible and will not be displayed in the public contact screen.

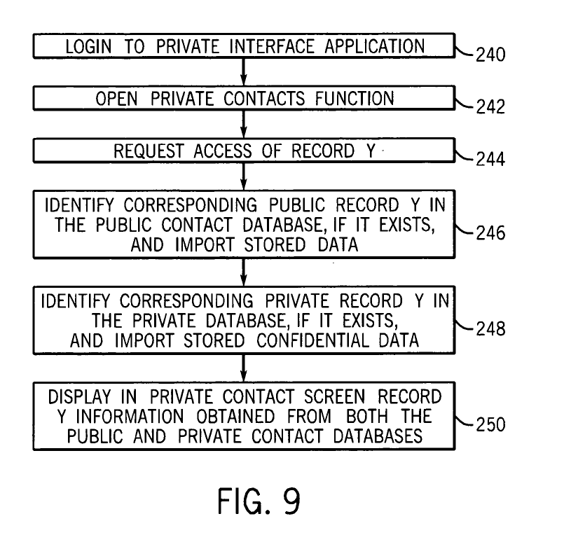

FIG. 9 shows exemplary steps of an embodiment of a method for displaying a private contact screen in accordance with an embodiment of the present invention. In step 240 the user logs into the PI application requiring at least the entry of a valid password. In step 242 the user opens the private contact function and requests access to a contact entry corresponding to record Y in step 244. In step 246 the PI application identifies the corresponding public record Y in the public contact database, if it exists, such as by comparing the record number of the private record with record numbers of records in the public database and imports the stored public data from this public record. In step 248 the PI application identifies the corresponding private record Y in the private contact database, if it exists, and imports the stored confidential data from this private record. The corresponding records in the public and private databases can be identified by the same record number, or alternatively by the same data in the name fields. In step 250 the private contact function displays a private contact screen containing information merged together and obtained from both the record Y in the public contact database and the corresponding record Y in the private contact database. The user may designate an entire record previously stored in the public contact database to now be confidential so that this record will be stored in the private database and deleted from the public database; this new private record can now only be accessed from the private contact screen. Such records can be accessed and displayed only from functions in the PI application.

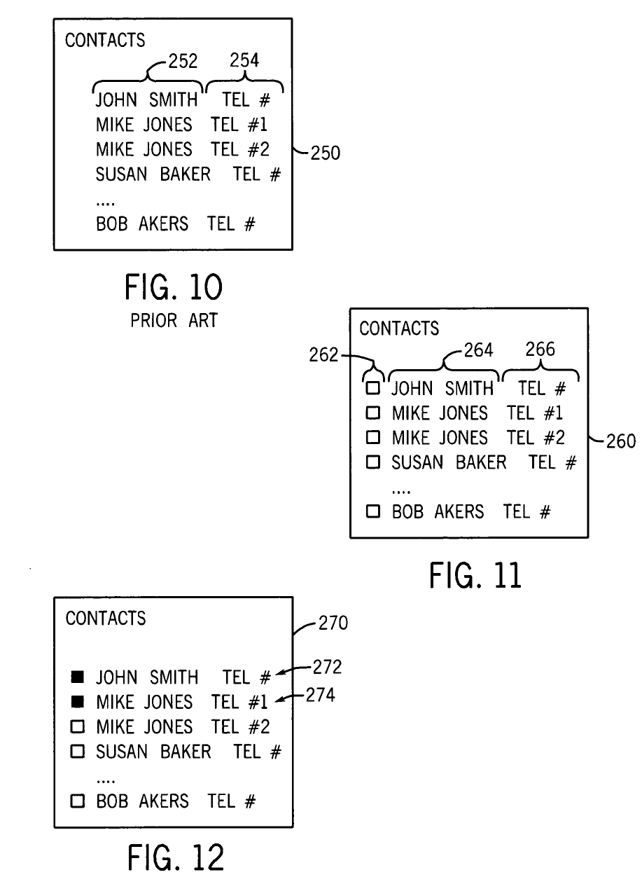

FIG. 10 shows an illustrative screen 250 of a wireless device in which the public contact function as known in the prior art, e.g. a Blackberry made by Research in Motion, is used to display members contained in the corresponding contact list stored in the wireless device. Each record maybe displayed as a separate row entry and includes a name field 252 and a corresponding telephone number field 254. In this known contact function, only one of the displayed entries at a time can be selected by the user, e.g. highlighted, with the corresponding selected entry being transferred as an addressee into the To field of the compose function. For example, to select members John Smith and Susan Baker as addressees listed in the To field of the compose function, the user would first select (highlight) one of these two members on the displayed screen of the contact function, go to the compose function screen which will show the selected member as an addressee, return to the screen displayed by the contact function and select the other of the two members, and return to the compose function screen which will now show both John Smith and Susan Baker as addressees in the To field as recipients to receive the corresponding message to be input by the user in the body portion of the compose function screen.

This process may prove cumbersome to the user, especially when there are a substantial number of recipients for a message. One disadvantage is that the user shuttles between the compose and contact (or pop up) screens in order to enter each additional message recipient. The user cannot simultaneously see the compose screen and the contact screen on the mobile device. Another disadvantage is that the user, after having entered several recipients to the To field in the compose function, may forget exactly which recipients have already been entered as addressees in the compose screen while viewing the contact screen. That is, the user may forget while viewing the members on the contact screen whether a particular member, that is to be a message recipient, is already listed as an addressee in the To field of the compose screen. This may cause the user to return to the compose screen without selecting a member in order to determine whether a particular member has already been entered in the To field of the compose screen.

FIGS. 11 and 12 show exemplary contact screens in accordance with an embodiment of the present invention. In contact screen 260 it will be seen that each member entry, e.g. each row, contains 3 separate fields: selection field 262, name field 264 and telephone number field 266. The selection field 262 provides the user with the capability of designating a plurality of members on the contact list to be recipients of a message during a single continuous display of the contact screen by appropriately selecting/flagging the corresponding selection field(s). At least the SMS address information, and preferably also the name, for all of the selected/designated members will be transferred, e.g. copied, to the To field of a compose screen with a single user operation, e.g. the user causing the display of the contact screen to change the display of the compose screen. The single user operation enables all of the selected addresses to be transferred to and shown in the address field of the compose screen without requiring the user to repeatedly select only a single contact and transfer that one contact to the message composition function/screen until all desired addresses are shown in the compose screen.

For example, as shown in the illustrative contact screen 270, member John Smith associated with entry 272 and member Mike Jones associated with entry 274 have each been selected by the user to be recipients of the message. In the exemplary embodiment, the selection field 262 for all members displayed in the contact screen includes visual indicia capable of indicating 2 different states, where one visual state indicates that the corresponding member has not been selected as a message recipient and the other visual state indicates that the corresponding member has been selected as a message recipient.

As seen in FIG. 11, the indicia shown in field 262 for each member consists of an unfilled square character indicating that no members have been selected as a message recipient. In FIG. 12, the square character associated with John Smith entry 272 and Mike Jones entry 274 is filled to form a solid dark square indicating that these two members have been selected as message recipients. This allows the user while viewing only the contact screen (i.e. without having to view the compose screen) to easily determine which members are selected as message recipients. While continuing to view the contact screen, the user can add additional message recipients by selecting the additional desired members which causes the character in the selection field 262 of the additional members to change state thus indicating the corresponding member as a message recipient.

The user may select and unselect members as shown on the contact screen by pointing to a member or the selection field of that member with a controllable cursor and clicking on a predetermined key or input button of the mobile device. Alternatively, the user may cause an entry (member) on the contact screen to be highlighted while clicking on a predetermined key. It will be understood that other graphical user interface techniques can be utilized to allow the user to select a desired member and provide an indication that the selection state of the member is to be toggled, i.e. alternated between selected and unselected states. It will also be understood that various types of different visual indicia can be utilized to distinguish members that are selected as message recipients from members that have not been selected. For example, different visual characters can be utilized to identify selected and not selected message recipients, e.g. different characters such as a check mark and lack of a check mark in a selection field area, different shading, different coloring, different fonts, different sizes, etc. The state of fields 262 for the members on the contact screen are stored so that upon the user going to or returning to the compose screen, selected members in the contact screen are all automatically copied to the To field of the compose screen thereby providing a single operation by which multiple addressees are entered in the To field. This also allows the user while viewing the contact screen to scroll through all members, visually determine which are selected as message recipients, and update the group selected to be recipients by deleting (unselecting) some and adding (selecting) others.

While viewing the compose screen, the user can delete one or more previously selected recipients by selecting that member(s) and pushing a designated delete function key. This will automatically cause an update of the state of the corresponding field 262 for that member(s) in the contact screen so such member(s) will be shown as not being a recipient upon the user causing the contact screen to be displayed.

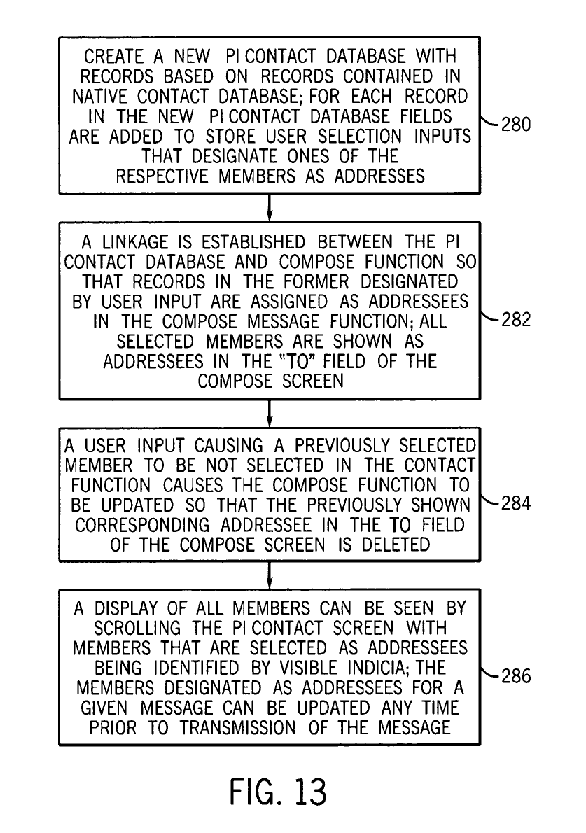

FIG. 13 is a flow diagram of an exemplary method by which the private contact function interacts with the private compose function on the wireless mobile device in accordance with the present invention. In step 280 a new PI private contact database is initially created with records based on the records contained in the native contact database provided by the manufacturer of the wireless mobile device. In addition to each record storing information about a respective member, e.g. the name and address information for the member, at least one recipient selection field is provided for each of the records in the PI private contact database, where this field is used to store a user input that designates whether the contact member associated with the respective record is designated to be a recipient of a message to be transmitted by the user.

In step 282 a linkage is established between the PI private contact database and the compose function. This linkage, e.g. a vector or index pointing to each selected contact entry, causes contact members associated with records having a selection field designating the respective member as a message recipient to be assigned as addressees in the compose message function. That is, all members selected by the user while viewing the displayed private contact screen will automatically be copied to the To field of the private compose function as a single operation and will be displayed in the To area of the compose screen. For example, this single operation may be triggered by the user providing an input causing the private contact screen being exited and the private compose screen to be displayed.

In step 284, the user while viewing the contact screen may cause a member previously selected to be a recipient to be unselected, i.e. to no longer be a recipient. The user may select a previously selected recipient in the contact screen thus causing the state of the selection field to be toggled from a selected state to an unselected state, with a corresponding change in the display of the selection field. Upon the single operation being again triggered by the user, the currently selected members will automatically be updated to the To field of the compose function. This will result in a member that had previously been selected and hence previously appeared in the To field of the compose screen to be deleted from the members shown in the To field if the respective member was unselected by the user in the contact screen. Prior to a message originated in the compose screen having been transmitted, the user may add or delete members to receive the subject message by going to the contact screen and making corresponding revisions of members designated to receive the message. Should a desired recipient not be a current member of the contact database, and hence will not appear in the listing of members on the contact screen, the recipient can be manually added to the contact database and then selected, or the address information associated with the recipient can be entered, e.g. typed, directly by the user into the To field in the compose screen.

In step 286 a display of all members of the contact database can be seen by scrolling the PI contact screen. Additionally, visual indicia is displayed on the contact screen for each member, i.e. each record, indicating whether the respective member has been selected by the user to be an addressee, i.e. a recipient of a message to be transmitted by the user of the wireless mobile device. This visual indicia corresponds to the selected or unselected state of the selection field for each member.

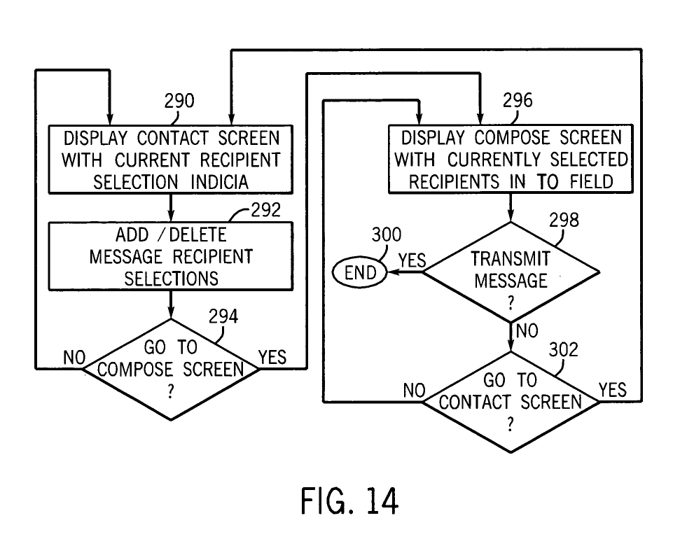

FIG. 14 is a flow diagram of an exemplary method for selecting multiple members in the private contact screen and updating the To field of the private compose screen to reflect those selected in the contact screen in one operation. In step 290 the contact screen with recipient selection indicia is displayed on the user's wireless mobile device. In step 292 the user adds and/or deletes the selection of members to be recipients of the message to be sent from the mobile device. In step 294 a decision is made by the user of whether to cause the compose screen to be displayed. A NO determination at step 294 results in the process returning to step 290. A YES determination by step 294 results in the mobile device displaying the compose screen with recipients as currently selected in the contact screen being shown in the To field as shown in step 296. A determination is made in step 298 of whether the message being composed is to be transmitted. A YES determination by step 298 results in the illustrative addressee selection process terminating as shown at END 300. Preferably, although not required, upon the transmission of the message, the contact screen is automatically reset so that no members are selected as message recipients. Thus, upon the next viewing of the contact screen following the transmission of a message the selection field for each member will reflect the unselected state. Similarly, on the initial power up of the mobile device and/or upon the initial entry into the IP application, the contact screen will reflect the unselected state for each member.

A NO determination by step 298 results in a determination in step 302 of whether the user has elected to have the contact screen shown. A NO determination by step 302 results in the process returning to step 296 in which the compose screen remains displayed. A YES determination by step 302 results in the process returning to step 290 in which the contact screen is displayed to the user. As will be appreciated, the user may switch back and forth between the contact and compose screens as desired. However, in this illustrative example only one of the contact and compose screens is displayed to the user at a time.

The mobile device in one example employs one or more computer-readable signal-bearing tangible media. The computer-readable signal-bearing media store software, firmware and/or assembly language for performing one or more portions of one or more embodiments of the invention. The computer-readable signal-bearing medium for the mobile device in one example comprises one or more of a magnetic, electrical, optical, biological, and atomic data storage tangible medium. For example, the computer-readable signal-bearing medium comprise random access memory, floppy disks, magnetic tapes, CD-ROMs, DVD-ROMs, hard disk drives, flash drives and electronic memory.

Although exemplary implementations of the invention have been depicted and described in detail herein, it will be apparent to those skilled in the art that various modifications, additions, substitutions, and the like can be made without departing from the spirit of the invention. Various hardware, software, firmware, and combinations thereof can be used to implement the functionality and characteristics described herein in a wireless mobile device.

The scope of the invention is defined in the following claims.

We claim:

1. A method implemented by a wireless mobile device for transmitting and receiving text-based messages, the method comprising the steps of:
storing public records in a public contact database in the mobile device, the public records containing public contact information for persons;
displaying, on the request of a public user of the device, on a screen of the mobile device public contact information contained in a public record corresponding to a person selected by the public user;
storing private records in a private contact database in the mobile device, the private records containing private contact information for persons;
upon a valid privacy password being received by the device from a private user, providing access to the private contact information to the private user;
displaying, in response to receipt of a request from the private user, on the screen of the mobile device private contact information for a selected person from a corresponding private record.

2. The method of claim 1 further comprising the step of determining that an entered password is valid by a privacy interface application operating on the device, the privacy interface application providing access to the private contact information to the private user.

3. The method of claim 1 further comprising the steps of:
determining if both a public record and a private record exists for a first person;
upon determining that both a public record and a private record exists for the first person, displaying, in response to receipt of a request from the private user for contact information about the first person, both the private contact information for the first person from the corresponding private record and the public contact information for the first person from the corresponding public record.

4. The method of claim 3 wherein the step of determining if both a public record and a private record exists for a first person comprises comparing a record number stored in the private record of the first person with record numbers stored in the public records, and upon finding a record number in a public record that matches the record number in the private record for the first person, determining that the public record with the matching record number is a public record for the first person.

5. The method of claim 1 further comprising the steps of:
determining if both a public record and a private record exists for a first person;
upon determining that both a public record and a private record exists for the first person, displaying, in response to receipt of a request from the public user for contact information about the first person, the public contact information for the first person from the corresponding public record, where private contact information for the first person is not accessible to the public user.

6. The method of claim 1 further comprising the steps of:
displaying on the screen of the mobile device a list of contacts based on stored contact information;
receiving user inputs while the screen displays the list of contacts where the inputs select a plurality of the contacts to be recipients of a message to be transmitted from the mobile device;
displaying visual indicia identifying each selected contact while the screen displays the list of contacts, and storing selection information that identifies the selected contacts;
transferring at least a communication address for each of the selected contacts based on the stored selection information to an address field for message composition, where all of the addresses for the selected contacts are transferred as a single user operation.

7. The method of claim 6 wherein the screen of the list of contacts and a screen showing message composition are not simultaneously displayed.

8. A tangible signal-bearing media readable by a wireless mobile device for transmitting and receiving text-based messages, the media comprising:
means in the media for storing public records in a public contact database in the mobile device, the public records containing public contact information for persons;
means in the media for displaying, on the request of a public user of the device, on a screen of the mobile device public contact information contained in a public record corresponding to a person selected by the public user;
means in the media for storing private records in a private contact database in the mobile device, the private records containing private contact information for persons;
means in the media for providing access to the private contact information to a private user after receipt of a valid privacy password by the device from the private user;
means in the media for displaying, in response to receipt of a request from the private user, on the screen of the mobile device private contact information for a selected person from a corresponding private record.

9. The media of claim 8 wherein further comprising means in the media for determining that an entered password is valid by a privacy interface application operating on the device, the privacy interface application providing access to the private contact information to the private user.

10. The media of claim 8 further comprising:
means in the media for determining if both a public record and a private record exists for a selected first person;
means in the media, upon determining that both a public record and a private record exists for the first person, for displaying, in response to receipt of a request from the private user for contact information about the first person, both the private contact information for the first person from the corresponding private record and the public contact information for the first person from the corresponding public record.

11. The media of claim 10 wherein the means in the media for determining if both a public record and a private record exists for a first person comprises comparing a record number stored in the private record of the first person with record numbers stored in the public records, and upon finding a record number in a public record that matches the record number in the private record for the first person, determining that the public record with the matching record number is a public record for the first person.

12. The media of claim 8 further comprising:
means in the media for determining if both a public record and a private record exists for a first person;
means in the media, upon determining that both a public record and a private record exists for the first person, for displaying, in response to receipt of a request from the public user for contact information about the first person, the public contact information for the first person from the corresponding public record, where private contact information for the first person is not accessible to the public user.

13. The media of claim 8 further comprising:
means in the media for displaying on the screen of the mobile device a list of contacts based on stored contact information;
means in the media for receiving user inputs while the screen displays the list of contacts where the inputs select a plurality of the contacts to be recipients of a message to be transmitted from the mobile device;
means in the media for displaying visual indicia identifying each selected contact while the screen displays the list of contacts, and storing selection information that identifies the selected contacts;
means in the media for transferring at least a communication address for each of the selected contacts based on the stored selection information to an address field for message composition, where all of the addresses for the selected contacts are transferred as a single user operation.

14. The media of claim 13 wherein the screen of the list of contacts and a screen showing message composition are not simultaneously displayed.

15. A wireless mobile device that transmits and receives text-based messages comprising:
memory that stores public records in a public contact database, the public records containing public contact information for persons;
a screen that displays information to the user;
means for accepting user inputs;
microprocessing unit that displays, on the request of a public user of the device, on the screen public contact information contained in a public record corresponding to a person selected by the public user;
the memory also stores private records in a private contact database, the private records containing private contact information for persons;
the microprocessing unit, upon determining a valid privacy password was received from a private user, provides access to the private contact information to the private user;
the microprocessing unit displaying, in response to receipt of a request from the private user, on the screen private contact information for a selected person from a corresponding private record.

16. The wireless mobile device of claim 15 wherein the microprocessing unit operates under the control of a privacy interface application that determines if that an entered password is valid and provides access to the private contact information to the private user.

17. The wireless mobile device of claim 15 further comprising:
the microprocessing unit determining if both a public record and a private record exists for a first person;
upon determining that both a public record and a private record exists for the first person, the microprocessing unit displaying, in response to receipt of a request from the private user for contact information about the first person, both the private contact information for the first person from the corresponding private record and the public contact information for the first person from the corresponding public record.

18. The wireless mobile device of claim 17 wherein the microprocessing unit determining if both a public record and a private record exists for a first person comprises the microprocessing unit comparing a record number stored in the private record of the first person with record numbers stored in the public records, and upon finding a record number in a public record that matches the record number in the private record for the first person, the microprocessing unit determining that the public record with the matching record number is a public record for the first person.

19. The wireless mobile device of claim 15 further comprising:
the microprocessing unit determining if both a public record and a private record exists for a first person;
upon determining that both a public record and a private record exists for the first person, the microprocessing unit displaying, in response to receipt of a request from the public user for contact information about the first person, the public contact information for the first person from the corresponding public record, where private contact information for the first person is not accessible to the public user.

20. The wireless mobile device of claim 15 further comprising:
the microprocessing unit displaying on the screen a list of contacts based on stored contact information;
the microprocessing unit receiving user inputs while the screen displays the list of contacts where the inputs select a plurality of the contacts to be recipients of a message to be transmitted from the mobile device;
the microprocessing unit displaying visual indicia identifying each selected contact while the screen displays the list of contacts, and storing selection information that identifies the selected contacts;
the microprocessing unit transferring at least a communication address for each of the selected contacts based on the stored selection information to an address field for message composition, where all of the addresses for the selected contacts are transferred as a single user operation, wherein the screen of the list of contacts and a screen showing message composition are not simultaneously displayed.
